(19) United States
(12) Patent Application Publication
(10) Pub. No.: US 2017/0344989 A1
(43) Pub. Date: Nov. 30, 2017

(54) Systems and Methods for Use in Facilitating Interactions Between Merchants and Consumers

(71) Applicant: MASTERCARD INTERNATIONAL INCORPORATED, Purchase, NY (US)

(72) Inventors: Randall Carey Brown, Hillsboro, MO (US); Christopher T. Scholl, Hazelwood, MO (US)

(21) Appl. No.: 15/167,078

(22) Filed: May 27, 2016

(51) Int. Cl. G06Q 20/40; G06Q 20/10; G06Q 20/20; G06Q 20/38

(52) U.S. Cl. CPC G06Q 20/401; G06Q 20/389; G06Q 20/10; G06Q 20/204

(57) ABSTRACT

Disclosed are exemplary embodiments of systems and methods for use in facilitating interactions between merchants and consumers. In an exemplary embodiment, a method generally includes receiving a request to initiate a transaction at a merchant for a product offered for sale by the merchant, where the request includes a credential for a payment account associated with a consumer. The method also includes assigning an order indicia to the request, and appending the order indicia to an authorization request associated with the transaction. The order indicia provides an indication relative to other transactions at the merchant of when the product will be ready for delivery by the merchant. The method further includes transmitting a notification to the consumer, via a communication device associated with the payment account, indicating the order indicia, whereby the consumer is able to claim the product associated with the transaction consistent with the order indicia.

### FIELD

The present disclosure generally relates to systems and methods for use in facilitating interactions between merchants and consumers, and in particular, to providing notifications to consumers indicating that merchants are prepared to deliver products to the consumers.

### BACKGROUND

This section provides background information related to the present disclosure which is not necessarily prior art.

Products (e.g., goods, services, etc.) are known to be offered for sale, and to be sold, by merchants. Consumers often fund purchases of such products through payment accounts. Certain products, when purchased, are not immediately available to the consumers such that the consumers are required to wait to receive the purchased products (e.g., products purchased from behind a counter (e.g., food, etc.), etc.). In such instances, the merchants often record the consumers' names, or provide the consumers with numbers or buzzers. Subsequently, when the products are ready, the merchants call the names of the consumers, or call numbers associated with the consumers, or cause the buzzers to activate. In response, the consumers then retrieve the products from the merchants. Also, it is known to distribute/assign numbers to consumers in advance of purchases, whereby the consumers are helped, or serviced, in an order consistent with their numbers.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating interactions between merchants and consumers;

FIG. 2 is a block diagram of a computing device that may be used in the exemplary system of FIG. 1;

FIG. 3 is an exemplary method for use in facilitating an interaction between a merchant and a consumer in connection with a payment account transaction by the consumer at the merchant, and which is suitable to be implemented in the system of FIG. 1; and

FIG. 4 is an exemplary interface, which may be displayed at a communication device in connection with an interaction between a merchant and a consumer in the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

When merchants service multiple consumers in a limited period to time, the consumers often must wait to interact with the merchants to purchase products (e.g., in lines at deli counters, in lines at post offices, in waiting areas at restaurants, etc.). Likewise, for certain products, once purchased, the consumers must wait for the merchants to deliver the products to the consumers (e.g., for ordered food, for certain electronic products, etc.). Depending on the number of consumers present at the merchants, the order of providing services and/or the order of delivery of products may be confused, resulting in errors and/or inefficiencies. Uniquely, the systems and methods herein enable merchants to provide notifications to consumers, whereby the consumers are informed, at communication devices associated with the consumers, that the merchants are ready to service the consumers and/or that the consumers' products are ready for delivery. In particular, when purchasing products, the consumers present payment devices to the merchants (e.g., virtual wallets, etc.). In turn, the merchants identify the communication devices of the consumers as associated with the products, based on an association between the communication devices and the presented payment devices (e.g., virtual wallets, etc.). The merchants then communicate with the consumers' communication devices to notify the consumers when they will be serviced by the merchants. As such, the consumers can be directly notified by the merchants, via their own communication devices, without need for further mediums of notification (e.g., paper numbers, electronic buzzers, etc.).

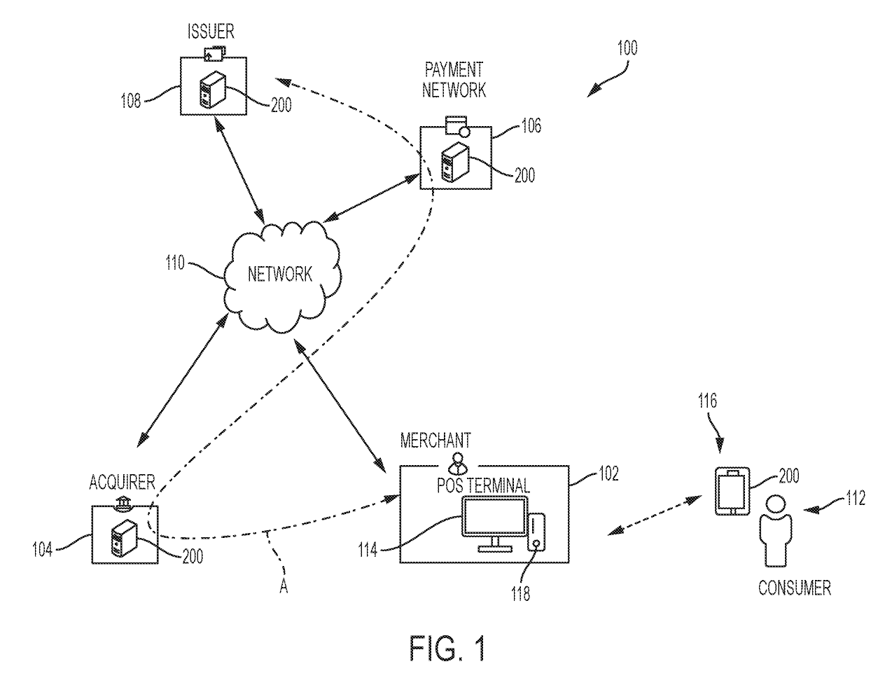

FIG. 1 illustrates an exemplary system 100, in which one or more aspects of the present disclosure may be implemented. Although, in the described embodiment, the system 100 is presented in one arrangement, other embodiments may include the system 100 arranged otherwise, depending, for example, on processing of transactions, types of merchants involved in the transactions, etc.

As shown in FIG. 1, the system 100 generally includes a merchant 102, an acquirer 104, a payment network 106, and an issuer 108, each coupled to (and in communication with) network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In this example, the network 110 may include a private payment transaction network made accessible by the payment network 106 to the acquirer 104 and the issuer 108 and, separately, a public network (such as the Internet) through which the merchant 102 and the acquirer 104 may communicate (e.g., via a website or via web-based applications, etc.).

In the system 100, the merchant 102 offers products (e.g., goods, services, etc.) for sale to consumers, such as consumer 112. The products often include goods and/or services, which require the merchant 102 to prepare and/or retrieve the products, or the consumer 112 to wait for delivery of the products in person (broadly, they require an order indicator to determine an order of servicing the consumers). In one example, products offered by the merchant 102 may include food items, which are prepared, cooked, and/or otherwise composed upon receiving a menu order from the consumer 112. In another example, products offered by the merchant 102 may include stored items, such that the consumer 112 selects and/or purchases a product based on a sample or description, and the merchant 102 then retrieves the actual product to be delivered to the consumer 112 from a store room or other accessible location. In a further example, products offered by the merchant 102 may include services such as, for example, vehicle services (e.g., oil changes, car washes, etc.), beauty treatments (e.g., manicures, pedicures, facials, massages, etc.), shipping services (e.g., parcel shipping, etc.), etc., where the consumer 112 waits for his/her turn (among other consumers) to receive a desired one of the services. With that said, it should be appreciated that any suitable product may be offered by the merchant 102 within the scope of the present disclosure. As such, above examples should be considered non-limiting.

The merchant 102 includes a point-of-sale (POS) terminal 114 through which transactions for the products involving the merchant 102 are coordinated. While one POS terminal 114 is shown in FIG. 1, it should be appreciated that the merchant 102 may have additional POS terminals, at a common location or at multiple different geographic locations, for coordinating transactions with consumers via payment accounts, cash, checks, gift cards, or other known forms of payment.

The consumer 112 in the system 100 is associated with a payment account, which may be used to fund purchases with merchants, including the merchant 102. In the illustrated embodiment, the payment account is issued to the consumer 112 by the issuer 108 (however, this is not required in all embodiments), and is associated with a payment device (e.g., a payment card, a fob, etc.). The consumer 112 is also associated with a communication device 116 (e.g., a smart phone, a tablet, etc.). In the illustrated embodiment, the communication device 116 includes a payment application such as, for example, an electronic wallet (or e-wallet) application (e.g., a virtual wallet application, etc.) (e.g., MasterPass®, Apple Pay®, Android Pay™, Samsung Pay®, PayPal®, Google Wallet®, etc.), which configures the communication device 116 to also act as a payment device for and/or with the consumer's payment account (and potentially one or more additional payment accounts associated with the consumer 112).

In an example transaction in the system 100, when the consumer 112 desires to make a purchase at the merchant 102, funded by the payment account (i.e., a payment account transaction), the consumer 112 presents the communication device 116 to the merchant 102 (using the payment application thereon), or another payment device associated with the payment account (broadly, as a transaction request). In particular, the consumer 112 presents the payment device (be it the communication device 116 (and associated payment application) or another payment device such as a payment card, fob, etc.) to the POS terminal 114 of the merchant 102. In turn, the POS terminal 114 reads payment account information (broadly, credentials) from the payment device for the consumer's payment account (e.g., from the consumer's communication device 116 as included in the payment application, etc.). The POS terminal 114 then generates and transmits an authorization request for the transaction along path A, as indicated in FIG. 1, to the acquirer 104 for processing.

In turn in the above example, the acquirer 104 communicates the authorization request with the issuer 108 (associated with the consumer's payment account) through the payment network 106, such as, for example, through MasterCard®, VISA®, Discover®, American Express®, etc. The issuer 108 determines whether the consumer's payment account is in good standing and whether there are sufficient funds and/or credit to fund the transaction. If approved, an authorization reply, or response (indicating the approval of the transaction), is transmitted back from the issuer 108 to the merchant 102 (specifically, back to the POS terminal 114), thereby permitting the merchant 102 to complete the transaction. The transaction is later cleared and/or settled (via appropriate transaction messages such as clearing messages and/or settlement messages, for example) by and between the merchant 102, the acquirer 104, and the issuer 108 (by appropriate agreements). If the transaction is declined, however, an authorization reply (indicating the decline of the transaction) is provided back to the merchant 102 (specifically, back to the POS terminal 114), thereby permitting the merchant 102 to halt or terminate the transaction, or request alternate funding.

Transaction data is generated, collected, and stored as part of the above interactions among the merchant 102, the acquirer 104, the payment network 106, the issuer 108, and the consumer 112. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, transaction data may be transmitted among parts of the system 100 as desired and/or necessary. As used herein, transaction data may include, for example (and without limitation), primary account numbers (PANs) for consumers involved in the transactions, amounts of the transactions, merchant IDs for merchants involved in the transactions, merchant category codes (MCCs), balances, payment history dates/times of the transactions/payments, incentives used (e.g., rebates discounts, etc.), order numbers or other order indicators, etc. It should be appreciated that more or less information related to transactions, as part of either authorization or clearing and/or settling, may be included in transaction records and stored within the system 100, at the merchant 102, the acquirer 104, the payment network 106 and/or the issuer 108.

In various exemplary embodiments, consumers (e.g., consumer 112, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions herein, subsequently for one or more of the different purposes described herein.

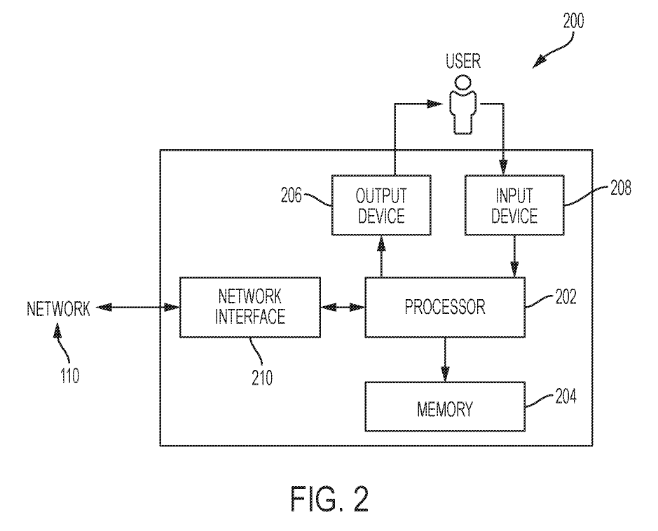

FIG. 2 illustrates an exemplary computing device 200 that can be used in the system 100 of FIG. 1. The computing device 200 may include, for example, one or more servers, workstations, routers, personal computers, tablets, laptops, smartphones, point-of-sale (POS) terminals, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the acquirer 104, the payment network 106, and the issuer 108 are illustrated as including, or being implemented in, computing device 200, coupled to (and in communication with) the network 110. In addition, while not shown, the merchant 102 may be implemented in and/or associated with at least one computing device consistent with computing device 200. Further, the POS terminal 114 associated with the merchant 102 and the communication device 116 associated with consumer 112 can each also be considered a computing device generally consistent with computing device 200 for purposes of the description herein.

The exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, payment account information, communication device information (e.g., associations between payment accounts and communication devices, etc.), order indicators, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes an output device 206 that is coupled to (and is in communication with) the processor 202. The output device 206 outputs information, for example, visually, audibly, etc., to a user of the computing device 200, such as, for example, the consumer 112, etc. It should be further appreciated that various interfaces (e.g., as defined by network-based applications, etc.) may be displayed at computing device 200, and in particular at output device 206, to display such information. The output device 206 may include, without limitation, a liquid crystal display (LCD), a light-emitting diode (LED) display, an LED, an organic LED (OLED) display, an “electronic ink” display, speakers, etc. In some embodiments, output device 206 includes multiple devices.

The computing device 200 also includes an input device 208 that receives inputs from the user (i.e., user inputs) such as, for example, selection of payment devices and/or payment accounts, etc. The input device 208 is coupled to (and is in communication with) the processor 202 and may include, for example, a keyboard, a pointing device, a mouse, a button, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 further includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some exemplary embodiments, the computing device 200 includes the processor 202 and one or more network interfaces (including the network interface 210) incorporated into or with the processor 202.

Referring again to FIG. 1, the system 100 further includes an order engine 118, which is configured, by executable instructions, to perform one or more operations described herein. As shown, the order engine 118 is incorporated at the merchant 102. More particularly in the illustrated system 100, the order engine 118 is included with the POS terminal 114 at the merchant 102 (and is configured to operate in conjunction with the POS terminal 114, for example, via common/shared executable instructions, etc. such that, in some embodiments, the POS terminal 114 may also be viewed as the order engine 118). However, it should be appreciated that the order engine 118 may be incorporated elsewhere in the merchant 102, may be incorporated in other parts of the system 100, and/or may be included as a standalone part of the system 100 (e.g., and coupled to (and in communication with) the POS terminal 114 and any desired additional POS terminals associated with the merchant 102 to thereby coordinate orders at the merchant 102 for multiple different consumers initiated at different ones of the POS terminals, etc.). With that said, for ease of reference, the following description is based on the POS terminal 114 (with the order engine 118 incorporated therein), with it understood that the description is equally applicable to the order engine 118 (either incorporated in the POS terminal 114 or located apart therefrom (e.g., when associated with multiple POS terminals etc.)).

In one aspect of the present disclosure, the order engine 118 may be implemented (via the POS terminal 114) in connection with a payment account transaction by the consumer 112 at the merchant 102 to purchase (and actually pay for) a product (as described in the above example payment account transaction). Here, when the consumer 112 uses the communication device 116 as the payment device, the POS terminal 114 is initially configured to determine an application identifier (App ID) for the payment application on the communication device 116, which is to be used in the transaction. In turn, the POS terminal 114 is configured to associate the App ID for the payment application with the consumer's communication device 116 (e.g., directly, upon receipt of an authorization reply, etc.). This allows the POS terminal 114 to subsequently identify the payment application, and the consumer's communication device 116, as described herein. Alternatively, the consumer 112 may use other tap-and-go technology (e.g., associated with tablets, wearable devices, etc.) to effect the transaction, and through which the POS terminal 114 can subsequently identify the consumer's particular device being used (via the account identified through the tap-and-go technology, for example).

Upon receiving the transaction request, the POS terminal 114 is configured to identify if the transaction involves (or requires) an order indicator (e.g., involves one of the various transactions described herein where the consumer 112 is required to wait for service or a good at the merchant 102, etc.). This may include simply determining that the transaction has been initiated using the payment application at the consumer's communication device 116 (where the POS terminal 114 identifies all transactions initiated with a payment application on a communication device or by other devices involving tap-and-go technology as involving an order indicator). Or, this may include determining that the transaction involves a particular type of transaction that requires an order indicator (e.g., based on an entry to the POS terminal 114 that the transaction is the particular type of transaction (e.g., an input to the POS terminal 114 of a particular product involved in the transaction, or an input to the POS terminal 114 requesting an order indicator for the transaction, etc.), etc.). In either case, when the transaction involves an order indicator, the POS terminal 114 (e.g., via the order engine 118, etc.) is configured to determine and assign an order indicia to the transaction. It should be appreciated that the order indicia may include any desired indicator of order of the consumer 112 at the merchant 102, relative to other consumers, such as, for example, numerical indicators (e.g., an order number, etc.), alphabetic indicators, color indicators, combinations thereof, etc.

In addition, the POS terminal 114 is configured to generate the authorization request for the transaction (as described above), and append the assigned order indicia to the authorization request. As an example, the authorization request may include a message consistent with the ISO 8583 standard. And, the POS terminal 114 may be configured to append the order indicia to a data element (DE) (e.g., DE 48, etc.) of the ISO 8583 message. The POS terminal 114 is configured to then transmit the authorization request (and the appended order indicia) to the issuer 108, via the acquirer 104 and the payment network 106 along path A in FIG. 1 (as described above). In turn, the POS terminal 114 is configured to receive the authorization reply (either approving or declining the transaction) from the issuer 108 (again, via the payment network 106 and the acquirer 104, along path A in FIG. 1), for use in subsequently processing the transaction (e.g., completing the transaction, stopping the transaction, etc.). In some embodiments, the authorization reply may identify the consumer's communication device 116 to the POS terminal 114, for use as described below.

Further, the POS terminal 114 is also configured to transmit the assigned order indicia to the consumer 112, at the consumer's communication device 116. In particular, the POS terminal 114 is configured to transmit a notification to the consumer's communication device 116, for example, via the payment application used to initiate the transaction (as identified via the App ID), indicating that the transaction has been initiated/received. In addition, the notification may include the order indicia assigned to the transaction, as well as various details for the transaction (e.g., a receipt for the transaction, etc.). The consumer 112 is then able to view the order indicia at the communication device 116, thereby enabling the consumer 112 to claim his/her product when ready (e.g., when later called by the merchant 102, etc.). Further, the notification (or a subsequent notification) may include a contemporaneous notification providing a status of the transaction (e.g., “You're Order is Ready”, etc.). It should be appreciated that transmittal of the order indicia (and other details of the transaction), via a notification, may take place at any time after the order indicia is assigned to the transaction, for example, before the authorization request is generated, after the authorization request is generated, after the POS terminal 114 receives the authorization reply, after the transaction is approved, etc.

In another aspect of the present disclosure, the order engine 118 may be implemented (via the POS terminal 114) in connection with a payment account transaction by the consumer 112, at the merchant 102, that is simply identified as involving an order indicator (and not necessarily involving the actual purchase of, and payment for, a product from the merchant 102). Here, the payment account transaction may include a null transaction (e.g., for $0.00, etc.), and which is utilized to assign an order indicia to the transaction for use by the consumer 112 as described herein (e.g., the consumer 112 simply requests a turn for service by the merchant 102, etc.). A subsequent transaction (e.g., a payment account transaction, a cash transaction, etc.) may then be performed by the consumer 112 at the merchant 102 to actually purchase the product, independent of the above payment account transaction. The null transaction may include an actual transaction for $0.00 processed through the acquirer 104, the payment network 106, and the issuer 108 as described above. Or, the null transaction may include a pre-authorization request (e.g., for $0.00, etc.), in which a pre-authorization reason (e.g., assign order indicia, etc.) is specified in a data element (DE) of the associated authorization request (e.g., in DE 3, Sub-element 1, of an ISO 8583 authorization message; etc.) thereby opening the order initiation and defining the transaction as a pre-authorization request verses another type of authorization.

In this aspect of the present disclosure, the POS terminal 114 is configured to operate substantially similar to the above description. For example, upon receiving the transaction request (for the null transaction), the POS terminal 114 is configured (as generally described above) to initially determine an App ID for the payment application (on the communication device 116) used in the transaction, and associate the App ID with the consumer's communication device 116. In addition, the POS terminal 114 is configured to assign an order indicia to the transaction, and append the assigned order indicia to an authorization request (or pre-authorization request) for the transaction. Further, the POS terminal 114 is configured to transmit the assigned order indicia to the consumer 112, at the consumer's communication device 116, so that the consumer 112 is able to view the order number (and other transaction details) at his/her communication device 116.

In a further aspect of the present disclosure, the order engine 118 may be implemented (via the POS terminal 114) in connection with a payment account transaction by the consumer 112, at the merchant 102, to solely identify a need for (or a request for) an order indicator (and not involving the actual purchase of, and payment for, a product from the merchant 102). Here, upon receiving the transaction request, the POS terminal 114 is configured (as generally described above) to initially determine an App ID for the payment application (on the communication device 116) used in the transaction, and associate the App ID with the consumer's communication device 116. In addition, the POS terminal 114 is configured to assign an order indicia to the transaction. The POS terminal 114 is then configured to transmit the assigned order indicia to the consumer 112, at the consumer's communication device 116 (e.g., via the payment application at the device 116, etc.), so that the consumer 112 is able to view the order number at his/her communication device 116 (independent of any authorization request for the transaction). A subsequent transaction (e.g., a payment account transaction, a cash transaction, etc.) may then be performed by the consumer 112 at the merchant 102 to actually purchase the product, independent of the above payment account transaction.

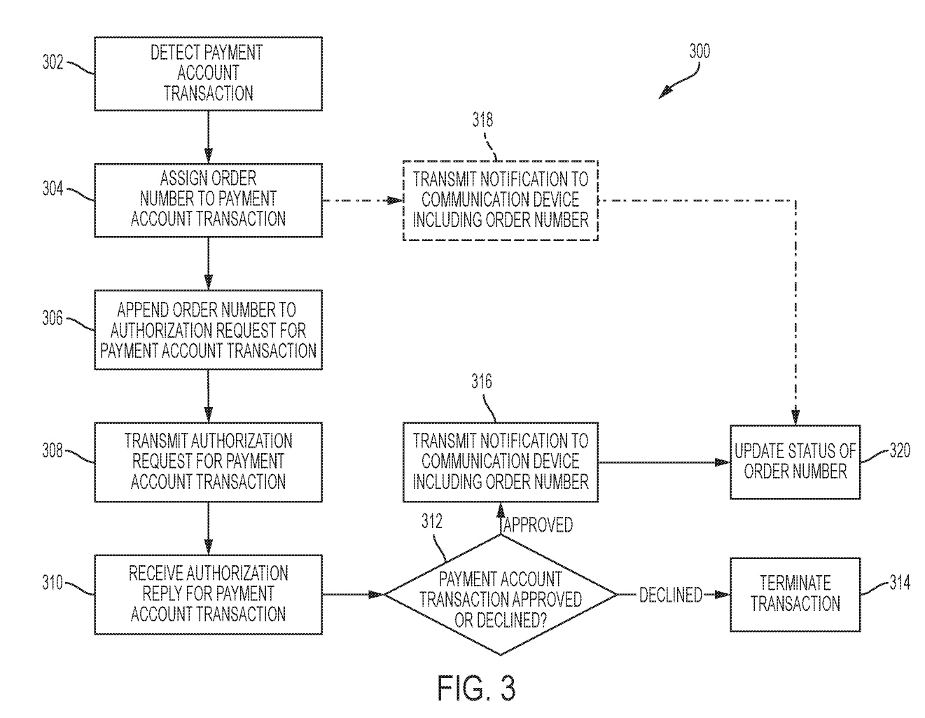

FIG. 3 illustrates an exemplary method 300 for use in providing a product to a consumer in connection with a payment account transaction between the consumer and a merchant. The method 300 is described with reference to the system 100, and in particular to the POS terminal 114 of the merchant 102, and to the computing device 200. The methods described herein (including the method 300), however, should not be considered to be limited to the system 100, or the computing device 200. Likewise, the systems and devices herein should not be considered to be limited to the method 300.

Generally in the method 300, the consumer 112 initially identifies a product from the merchant 102 for purchase, and presents the communication device 116 (and associated payment account, via the payment application on the communication device 116) to the POS terminal 114 to initiate a payment account transaction in connection with the product (broadly, to initiate a request for the product). In so doing, the consumer 112 may initiate the payment account transaction for the value of the product, in an attempt to actually purchase the product. Or, the consumer 112 may initiate the payment account transaction for a null amount, to simply obtain an order indicia for the product as described herein (and then subsequently purchase the product from the merchant 102 in another transaction). In either case, the consumer's communication device 116, via the payment application, is associated with the transaction. In addition, as can be see, the method 300 may be applied in connection with a product actually purchased at merchant 102, or in connection with no purchase.

In turn in the method 300, the POS terminal 114 detects the payment account transaction, at 302, and generates an authorization request for the transaction. In so doing, the POS terminal 114 includes the appropriate transaction data in the request for the transaction, for example, based on the type of payment account transaction initiated (e.g., the actual value of the product when desired to actually purchase the product, a null value when desired to simply obtain an order indicia, etc.), etc. It should be appreciate that the POS terminal 114 may detect the payment account transaction based on the consumer's interaction with the POS terminal 114, based on the communication device's interaction with the POS terminal 114, and/or based on the POS terminal's activity. In conjunction with detecting the payment account transaction, the POS terminal 114 identifies the communication device 116, and in particular, the payment application on the device 116, by its App ID. As described above, the App ID is unique to the communication device 116, and is further unique to the payment application thereon, whereby subsequent communications from the POS terminal 114 may be directed to the consumer 112, at the communication device 116, by use of the App ID.

Next, the POS terminal 114 assigns an order number (broadly, an order indicia) to the payment account transaction, at 304. In the method 300, the merchant 102 includes one POS terminal 114, and each payment account transaction at the merchant is initiated through the POS terminal 114, such that the POS terminal 114 (via the order engine 118) simply increments a last assigned order number to identify a next order number and then assigns the order number to the payment account transaction. In other embodiments, the order engine 118 may be implemented across multiple POS terminals at the merchant 102 and may coordinate among the multiple POS terminals to reduce the chances of assignment of the same order number to different payment account transactions in close temporal proximity. As such, the order engine 118 may coordinate among the multiple POS terminals and sequentially assign order numbers, regardless of which POS terminal is involved in the payment account transactions. Further, the order engine 118 may be given a start number at the beginning of the day, the week, or another interval, whereby overlap between order numbers in a similar temporal period is unlikely. Alternatively, multiple order engines may be employed (e.g., one per POS terminal, etc.), each of which interact to coordinate the assignment of order numbers in a sequential manner (again, to avoid potential overlap, etc.).

After assigning the order number to the payment account transaction, the POS terminal 114 appends the order number to the authorization request, at 306, and transmits the authorization request, at 308, to the issuer 108 (associated with the consumer's payment account), for example, along path A in FIG. 1 (as described above). The POS terminal 114 may append the order number to any available part of the authorization request, as long as the position is designated for the order number and/or is unused for other data captured by the merchant 102, the acquirer 104, the payment network 106, and/or the issuer 108, or other entity interpreting the authorization request for the order number. For example, as described above, when the authorization request includes a 0100 message or 0200 message consistent with the ISO 8583 standard, the order number may be appended to DE 48, sub-element 121, or DE 55. It should be appreciated that other data elements, in an ISO 8583 message of other types, may be employed to carry the order number, as necessary or desired.

With continued reference to FIG. 3, once the POS terminal 114 transmits the authorization request (and appended order number) to the issuer 108, the POS terminal 114 subsequently receives an authorization reply, at 310, from the issuer 108 (or payment network 106), indicating whether the payment account transactions is approved or declined. If the authorization reply indicates the payment account transaction is declined, at 312, particularly where the payment account transaction involves the actual purchase of the product from the merchant 102, the POS terminal 114 indicates the decline and terminates the payment account transaction, at 314. The consumer 112 may then, for example, be invited to provide another form of payment for the product.

Conversely, if the authorization reply received at the POS terminal 114 indicates the payment account transaction is approved, at 312, the order engine 118 transmits a notification to the communication device 116, at 316, identifying the order number to the consumer 112. The consumer 112 is then able to view the order number, so that he/she can claim the product when ready (e.g., when the order number is later called by the merchant 102, etc.). In addition, when the payment account transaction involves the actual purchase of the product, the notification may also include a receipt for the payment account transaction (e.g., identifying the order number, the product purchased, an amount associated with the transaction, etc.).

As described above, the notification may be transmitted to the consumer's communication device 116 via the payment application included thereon (e.g., as identified via the App ID, etc.). Such notification from the merchant 102 may cause the payment application to indicate the notification to the consumer 112, for example, by an audible and/or visual indicator at the communication device 116. In one example, the communication device 116 vibrates or “dings” in response to the notification. Alternatively, the notification may be transmitted to the communication device 116 via a short message service (SMS) message, email, etc. Here, the POS terminal 114 may be informed of a phone number or email address for the communication device 118 through the consumer's payment application, or upon direct entry thereof by the consumer 112 to the POS terminal 114 (i.e., as a user input to the POS terminal 114)

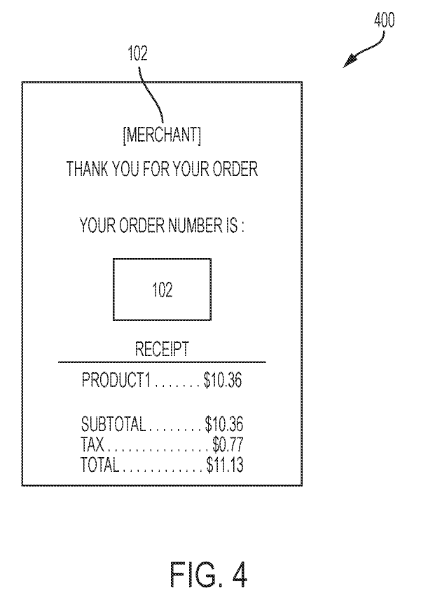

FIG. 4 illustrates an exemplary interface 400, which may be transmitted by the POS terminal 114 to the consumer 112, at the communication device 116, in connection with a notification. As shown, the interface 400 includes an order number for the consumer's payment account transaction, i.e., “102.”. The interface 400 also includes the name of the merchant 102, and a “Thank you” message. In addition, the interface 400 includes a receipt for the payment account transaction, identifying particular details of the product purchased and the underlying purchase (e.g., product price, tax, etc.).

Referring again to FIG. 3, optionally in the method 300 (as indicated by the dotted lines in FIG. 3), after assigning the order number to the payment account transaction (and prior to or contemporaneously with associating the order number with the authorization request), the POS terminal 114 may transmit a notification to the consumer 112, at the communication device 116, at 318, identifying the order number to the consumer 112. For example, POS terminal 114 may communicate the order number to the communication device 116, as part of the initial interaction between the POS terminal 114 and the payment application of the communication device 118, through which the POS terminal received the payment account credentials. In response, the communication device 116 is able to display the order number to the consumer 112, via the payment application.

Then in the method 300, at 320, the POS terminal 114 updates the consumer 112 as to a status of current service for the merchant 102, and the order number assigned to the payment account transaction. This may include, for example, the POS terminal 114 transmitting an update notification to the consumer 112, at the consumer's communication device 116, identifying the order number currently being serviced, or an estimated wait time before the consumer's order number is serviced, etc. This may also include, for example, the POS terminal 114 transmitting a notification to the consumer 112, via the communication device 116, when the product is ready and/or the order number is next to be ready.

In the illustrated method 300, while the order number is assigned, by the POS terminal 114, upon the detection of the payment account transaction, it should be appreciated that the order number may be assigned subsequently in the method 300 including, for example, after the payment account transaction is approved by the issuer 108 (e.g., upon receiving an authorization reply from the issuer 108 approving the payment account transaction, etc.). In such an example, the order number may not be assigned to the authorization request, but instead may be appended to settlement and/or clearing data at the merchant 102, via the POS terminal 114, or may be omitted from data to/from the acquirer 104, the payment network 106 and/or the issuer 108 (and simply transmitted to the consumer 112 in a notification).

In view of the above, the systems and methods herein provide indicators to consumers of when they will be serviced by merchants, uniquely based on payment accounts, instead of using traditional mediums of indicators such as paper tickets, buzzers, etc. In addition, the consumers can be provided the indictors, via appropriate notifications, at their own communication devices, thereby eliminating the need for use of separate mediums by the merchants to provide the indicators. Further, the merchants may be able to limit the number of false, or uncommitted, requests for service by committing the consumers to payment in advance.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by (a) receiving a request to initiate a transaction, by a consumer, at a merchant for a product offered for sale by the merchant, the request including a credential for a payment account associated with the consumer; (b) assigning an order indicia to the request; (c) appending the order indicia to an authorization request associated with the request, the order indicia being unique to the transaction relative to one or more other transactions at the merchant and providing an indication relative to the other transactions of when the product will be ready for delivery by the merchant; (d) transmitting a notification to the consumer, via a communication device associated with the payment account, indicating the order indicia, whereby the consumer is able to claim the product associated with the transaction consistent with the order indicia; and (e) transmitting another notification to the consumer, via the communication device associated with the payment account, when the product associated with the transaction is ready to be delivered and/or the order indicia is next to be serviced.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” “included with,” or “in communication with” another element or layer, it may be directly on, engaged, connected or coupled to, associated with, or in communication with the other element or layer, or intervening elements or layers may be present. As used herein, the term “and/or” includes any and all combinations of one or more of the associated listed items.

In addition, as used herein, a product may include a service, a good, etc.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating interactions between merchants and consumers, the method comprising:
receiving a request to initiate a transaction, by a consumer, at a merchant for a product offered for sale by the merchant, the request including a credential for a payment account associated with the consumer;
assigning, by a computing device, an order indicia to the request;
appending the order indicia to an authorization request associated with the transaction, the order indicia being unique to the transaction relative to one or more other transactions at the merchant and providing an indication relative to the other transactions of when the product will be ready for delivery by the merchant; and
transmitting, by the computing device, a notification to the consumer, via a communication device associated with the payment account, indicating the order indicia, whereby the consumer is able to claim the product associated with the transaction consistent with the order indicia.

2. The method of claim 1, wherein the order indicia includes an order number; and
further comprising receiving an authorization reply indicative that the payment account transaction is authorized; and
wherein transmitting a notification to the consumer includes transmitting the order number to the consumer, via the communication device, in response to the authorization reply.

3. The method of claim 1, further comprising transmitting, by the computing device, another notification to the consumer, via the communication device associated with the payment account, when the product associated with the transaction is ready to be delivered and/or the order indicia is next to be serviced.

4. The method of claim 1, wherein appending the order indicia to an authorization request includes appending the order indicia to a data element (DE) of the authorization request, consistent with an ISO 8583 standard.

5. The method of claim 4, wherein appending the order indicia to a data element (DE) of the authorization request includes appending the order indicia to DE 48 of the authorization request.

6. The method of claim 1, wherein the order indicia includes an order number; and
further comprising determining, by the computing device, the order number based on at least a prior transaction at a point-of-sale (POS) terminal at the merchant.

7. The method of claim 6, wherein transmitting a notification to the consumer includes transmitting the notification to a payment application included in the communication device associated with the payment account.

8. The method of claim 7, wherein receiving a request to initiate a transaction includes receiving the payment account credential from the payment application.

9. The method of claim 1, wherein the transaction includes a null transaction.

10. A system for use in facilitating interactions between merchants and consumers, the system comprising:
a processor coupled to a memory including executable instructions, which when executed by the processor, cause the processor to:
assign an order number to a request to initiate a payment account transaction at a merchant for a product, the request involving a payment account associated with a consumer, and the order number providing an indication relative to other requests to initiate transactions at the merchant of when the merchant will provide the product to the consumer; and
transmit a notification to the consumer, at a communication device associated with the consumer, when the merchant is prepared to provide the product to the consumer.

11. The system of claim 10, wherein the order number includes at least one alphabetic character and/or at least one numeric character.

12. The system of claim 10, further comprising a point-of-sale (POS) terminal including said processor and said memory;
wherein the executable instructions, when executed by the processor, further cause the processor to receive the request to initiate the transaction at the POS terminal.

13. The system of claim 12, wherein the executable instructions, when executed by the processor, further cause the processor to transmit the order number to the communication device, prior to transmitting the notification when the merchant is prepared to provide the product to the consumer.

14. The system of claim 12, wherein the executable instructions, when executed by the processor, further cause the processor to transmit an update to the communication device, indicating the order number relative to a consumer currently interacting with the merchant.

15. The system of claim 12, wherein the executable instructions, when executed by the processor, further cause the processor to:
generate an authorization request for the payment account transaction;
append the order indicia to the authorization request; and
direct the authorization request to an issuer associated with the consumer's payment account.

16. The system of claim 10, wherein the product is selected from the group consisting of a good and a service.

17. A computer-implemented method for use in facilitating interactions between merchants and consumers, the method comprising:
receiving, at a computing device, a request associated with a payment device of a consumer;
assigning, by the computing device, an order indicia to the request; and
in response to at least the request, transmitting a notification to the payment device, whereby the consumer is informed of an order of service of the consumer by the merchant, relative to a least one other consumer.

18. The method of claim 17, wherein the request includes a transaction request to initiate a transaction for a product at the merchant to a payment account.

19. The method of claim 18, wherein the payment device includes a portable communication device comprising a payment application having the payment account to which the transaction is initiated.

20. The method of claim 19, further comprising generating, by the computing device, an authorization request for the transaction and transmitting the authorization request to an issuer associated with the payment account.
